(19) United States
(12) Patent Application Publication
(10) Pub. No.: US 2008/0117065 A1
(43) Pub. Date: May 22, 2008

(54) Sensing Chamber with Enhanced Ambient Atmospheric Flow

(75) Inventor: Scott R. Lang, Geneva, IL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/561,532

(22) Filed: Nov. 20, 2006

(51) Int. Cl. G08B 17/10

(52) U.S. Cl. 340/628

(57) ABSTRACT

A sensing chamber promotes an inflow of ambient atmosphere by establishing an internal temperature gradiant. A closed loop control system can be provided to maintain the gradiant.

### FIELD

The invention pertains to ambient condition detectors, such as smoke detectors. More particularly, the invention pertains to such detectors which include sensing chambers which promote an inflow of ambient atmosphere.

### BACKGROUND

Ambient condition detectors have been found to be useful in providing an indication of the presence of the respective condition. Smoke detectors have been found useful in providing early warnings of the presence of airborne particulate matter such as smoke.

Known smoke detectors often include a housing with an internal smoke chamber. Either an ionization-type or a photoelectric-type smoke sensor can be located in the housing.

Vents are located in the housing. Ambient air circulates into and out of the housing in response to movement of the adjacent atmosphere.

Air circulation in a region being monitored does bring the airborne particulate matter into the housing. Depending on the nature of the air currents, this can be faster or a slower process.

In large commercial buildings air circulation is often achieved by centralized heating and cooling systems. Building control systems alter air flow in response to preset schedules. Hence, there may be time of minimal or no circulation such as evenings or weekends. There continues to be a need for solutions to these minimal or no circulation situations.

### BRIEF DESCRIPTION OF THE DRAWINGS

FIG. 1 is a cut-away side elevational view of a sensoring chamber in accordance with the invention; and

FIG. 2 is a schematic diagram of an ambient condition detector which embodies the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

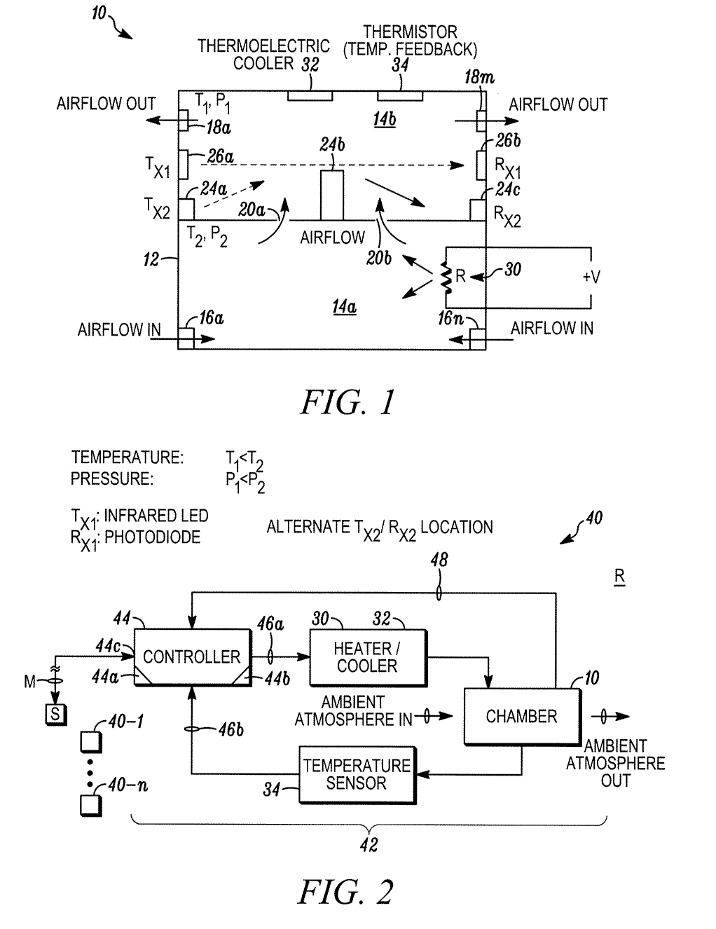

FIG. 1 is a side elevational view of a photoelectric smoke sensing chamber 10 which embodies the invention. Chamber 10 includes a housing 12 which can assume a variety of shapes without departing from the spirit and scope of the invention.

Housing 12 defines interior regions 14a, b. Region 14a includes one or more atmospheric inflow ports 16a, b - - - n. Region 14b includes one or more atmospheric outflow ports 18a, b - - - n. One or more flow openings 20a, b - - - l enable ambient atmosphere to flow between regions 14a, b.

In one form, chamber 10 can be configured as a scattering-type smoke sensor with a source 24a, a light emitting (infrared for example) diode, a septum 24b and a sensor of scattered light 24c. Alternately, chamber 10 can be configured as an obscuration-type smoke sensor with a radiant energy source 26a and sensor 26b. Outputs from sensors 24c or 26b are indicative of smoke in the region 14b.

Those of skill in the art will recognize that the invention finds application ionization-type smoke chambers as well as gas sensing chambers (for example CO, CO₂, N) all without limitation.

Chamber 10 creates a temperature and or pressure gradiant between regions 14a, b. This gradiant promotes atmospheric in flow, via ports 16a, 6 - - - n, through openings 20a, b - - - l and an outflow, via ports 18a, b - - - m. That gradiant produces enhanced smoke, or gas detection especially in conditions of relatively still ambient atmosphere outside of chamber 10. The gradiant can be established by at least one electrical heating element 30 (preferably a static resistive element) carried in region 14a by housing 12.

Alternately or in addition, at least one solid state cooling element 32, (a thermoelectric cooler, for example) can be carried in region 14b by housing 12. A temperature sensing element 34 (a thermistor for example could also be carried in region 14b by housing 12. It will be understood that a plurality of elements 30, 32, 34 could be used without departing from the spirit and scope of the invention.

FIG. 2 is a schematic diagram of a smoke or gas detector 40 in accordance with the invention. Detector 40 has a housing 42 which carries, in an internal region, chamber, gradiant establishing elements 30, 32 and feedback element 34. A controller 44, which could be implemented in part by at least one programmable processor 44a and executable control software 44b, produces temperature, pressure control signals 46a to enable heater 30 and cooling element 32 to establish the temperature or pressure gradiant(s) in chamber 10. Controller 44 also receives feedback signals 46b from sensor 34 to implement a closed loop control system. Those of skill in the art will understand that details of the control processing, to generate the gradiant in chamber 10 are not limitations of the invention.

Feedback signals 48 from chamber 10 couple an indicator of smoke or gas concentration to controller 44 for alarm condition processing as would be known to those of skill in the art. Controller 44, via interface 44c, and wired or wireless medium M can communicate with a regional alarm system S. A plurality of detector 40-1 - - - n, like detector 40 can be coupled to system S to monitor conditions in region R.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A sensing chamber comprising:
a hollow housing having at least one inflow port and at least one outflow port; and
a non-movable flow inducing element carried in the housing to create a temperature gradient therein.

2. A chamber as claimed in claim 1 wherein the element comprises at least one of a heating element, or a cooling element.

3. A chamber as in claim 1 which includes a temperature indicating feedback element.

4. A chamber as in claim 3 which includes a source of radiant energy and a sensor thereof.

5. A chamber as in claim 4 where the temperature gradient induces flow of ambient atmosphere into the chamber.

6. A chamber as in claim 5 where the housing has first and second internal regions with the flow inducing element carried in one of the regions.

7. A chamber as in claim 6, where at least one flow inducing element is located in a region associated with the inflow port.

8. A chamber as in claim 7 where at least one flow inducing element is located in a region associated with the output port.

9. A chamber as in claim 6 which includes a non-movable heating element and a non-movable cooling element, both carried in the housing.

10. A chamber as in claim 6 which includes temperature regulating circuitry coupled to the flow inducing element and the feedback element.

11. A detector comprising:
an aspirated sensing chamber that includes a flow inducing atmospheric heating element.

12. A detector as in claim 11, the detector having a housing which carries the chamber.

13. A detector as in claim 11 which includes closed loop temperature control circuitry.

14. A detector as in claim 13 where the chamber includes an atmospheric cooling element.

15. A detector as in claim 14 where the sensing chamber includes inflow port and an outflow port.

16. A method comprising:
establishing a region for sensing an airborne ambient condition;
establishing a temperature gradient across at least part of the region to induce an inflow of ambient atmosphere into the region; and
sensing a concentration of the ambient condition in the region.

17. A method as in claim 16 where establishing a temperature gradiant includes heating ambient atmosphere in part of the region.

18. A method as in claim 17 where establishing a temperature gradiant includes cooling ambient atmosphere in part of the region.

19. A method as in claim 16 which includes sensing a temperature parameter and adjusting the gradiant accordingly.
